(19) United States
(12) Patent Application Publication
(10) Pub. No.: US 2020/0072396 A1
(43) Pub. Date: Mar. 5, 2020

(54) FLUID HOSE AND METHOD OF MAKING THE SAME

(71) Applicant: Caterpillar Inc., Deerfield, IL (US)

(72) Inventor: William T. SCHOENAU, Washington, IL (US)

(73) Assignee: Caterpillar Inc., Deerfield, IL (US)

(21) Appl. No.: 16/118,866

(22) Filed: Aug. 31, 2018

(51) Int. Cl. F16L 11/08; B29C 47/00; B29C 63/10

(52) U.S. Cl. CPC F16L 11/08; B29C 47/0064; B29L 2023/005; B29C 63/10; B29C 47/0026

(57) ABSTRACT

According to one aspect, the present disclosure includes a fluid hose. The fluid hose may include an inner liner, a reinforcement layer located radially outside of the inner liner, and a cover. The reinforcement layer including one or more preformed ribbons having a plurality of wires formed in a strip of cushioning material.

### TECHNICAL FIELD

The present disclosure relates generally to fluid hoses, such as hydraulic hoses, and methods of manufacturing the same.

### BACKGROUND

Fluid hoses, such as hydraulic hoses, typically include an inner liner, wire reinforcement layers with alternating cushion layers, and an exterior layer or cover. U.S. Pat. No. 4,175,992 A (“the '992 patent”) to Grawey discloses a process of manufacturing a hydraulic hose that includes sequentially wrapping a mandrel with a fabric layer, an uncured elastomer layer, a bond stock layer, and a plurality of reinforcement wires. The plurality of reinforcement wires are applied in a side-by-side series of convolutions on the surface of a bond stock layer by means of a winding deck that rotates about the mandrel. Reinforcement layers are formed by winding separate reinforcement wires at the same time from spools of reinforcement wires onto the formed layers of the hydraulic hose (i.e., a built-up core structure). The number of reinforcement wires could, for example, range from fifty (50) to one-hundred and fifty (150), depending on the diameter of the layer and the winding angle of the reinforcement wire.

During this hydraulic hose manufacturing process, control of the reinforcement wires may lead to tension differences as the wires are wound about the hose. Such tension differences can cause the reinforcement wires to have radial variations that can cause a rubbing friction between adjacent hose layers, and eventual failure of the hose. Also, tension differences in applying the reinforcement wires can create gaps between adjacent reinforcement wires that can lead to a rupture failure of the hose when conveying highly pressurized fluid. Finally, the different reinforcement wire tensions may cause the wires to overlap and become twisted, which may also cause rubbing friction between the hose layers, and possibly cause premature failure of the hose.

The systems and methods of the present disclosure may solve one or more of the problems set forth above and/or other problems in the art. The scope of the current disclosure, however, is defined by the attached claims, and not by the ability to solve any specific problem.

### SUMMARY OF THE DISCLOSURE

According to one aspect, the present disclosure includes a fluid hose. The fluid hose may include an inner liner, a reinforcement layer located radially outside of the inner liner, and a cover. The reinforcement layer including one or more preformed ribbons having a plurality of wires formed in a strip of cushioning material.

According to another aspect, the present disclosure includes a ribbon for use in forming a hydraulic hose. The ribbon may include a plurality of wires and a strip of cushioning material, the plurality of wires being formed in the strip of cushioning material.

According to yet another aspect, the present disclosure includes a method of making a fluid hose. The method may include forming an inner liner, forming a reinforcement layer radially outside the inner liner, and forming a cover radially outside the reinforcement layer. The forming of the reinforcement layer includes helically winding one or more ribbons radially outside the inner liner, the ribbons including a plurality of wires arranged in a strip of cushioning material.

### BRIEF DESCRIPTION OF THE DRAWINGS

FIG. 1 is a perspective view of an exemplary fluid hose according to the present disclosure.

FIG. 2 is a cross-sectional view of the hose of FIG. 1.

FIG. 3 is a perspective view of a preformed ribbon of the hose of FIG. 1.

FIG. 4 is a flow chart for a process of manufacturing the ribbon of FIG. 3.

FIG. 5 is a perspective view of the hose of FIG. 1 during a step in the manufacturing process.

FIG. 6 is a flow chart of a process of manufacturing the hose of FIG. 1.

### DETAILED DESCRIPTION

Both the foregoing general description and the following detailed description are exemplary and explanatory only and are not restrictive of the features, as claimed. As used herein, the terms “comprises,” “comprising,” “having,” “including,” or other variations thereof, are intended to cover a non-exclusive inclusion such that a process, method, article, or apparatus that comprises, has, or includes a list of elements does not include only those elements, but may include other elements not expressly listed or inherent to such a process, method, article, or apparatus.

In this disclosure, relative terms, such as, for example, “about,” substantially,” “generally,” and “approximately” are used to indicate a possible variation of ±10% in the stated value. The term “exemplary” is used in the sense of “example” rather than “ideal.” As used herein, the singular forms “a,” “an,” and “the” include plural reference unless the context dictates otherwise.

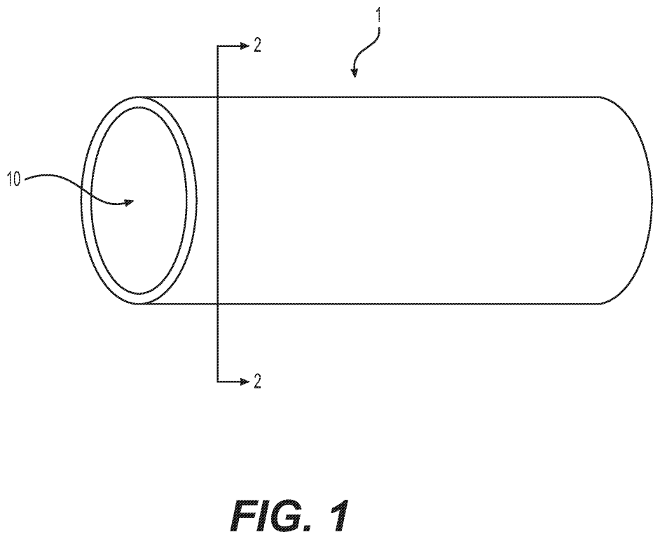

FIG. 1 is a perspective view of an exemplary fluid hose 1 according to the present disclosure. Hose 1 may be, for example, a hydraulic hose 1 that includes a lumen 10 for conveying hydraulic liquids through the hose 1. While this disclosure will be described with reference to a hydraulic hose 1, the disclosure is not limited to only hoses that convey hydraulic fluid. Hose 1 can convey any type of fluid (liquid or gas). Hose 1 may be used with any type of system, such as, for example, hydraulic systems for industrial or mobile heavy machinery, or any other system that uses a hose.

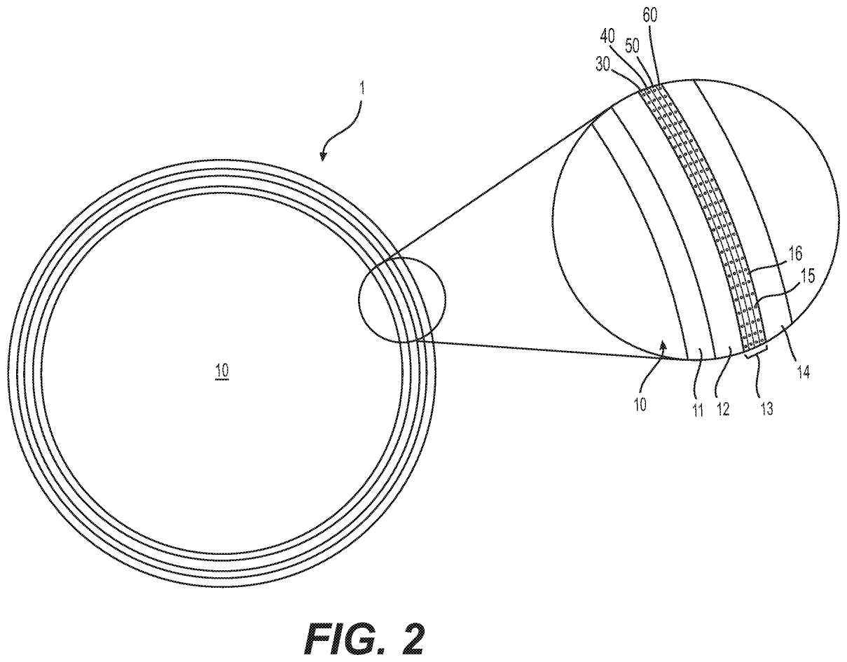

FIG. 2 is a cross-sectional view of the hydraulic hose 1 taken along line 2-2 in FIG. 1. Hydraulic hose 1 may include, from the hose lumen 10 radially outward, an inner liner 11, a cushion layer 12, a ribbon reinforcement layer 13, and a cover 14. While the hydraulic hose 1 will be described with these layers, it is understood that hose 1 may include more or less layers, and the arrangement (radial position) of the layers may be modified.

The inner liner 11 of hydraulic hose 1 may be a barrier between a pressurized fluid in lumen 10 and the exterior layers (i.e., cushion layer 12, ribbon reinforcement layer 13, and cover 14) so that the exterior layers do not come into contact with the pressurized fluids. The inner liner 11 may be formed of materials providing the desired flexibility and appropriate compatibility with the conveyed fluid to protect against any corrosive effects of the conveyed fluid. The inner liner 11 may also be formed of a material that includes a flow-facilitating surface to reduce friction and material build-up. For example, inner liner 11 may be formed of a synthetic rubber, thermoplastic, or PTFE (Teflon), and may include any appropriate coating.

The cushion layer 12 of hydraulic hose 1 may be a barrier between the inner liner 11 and the ribbon reinforcement layer 13, to help ensure that the inner liner 11 does get detrimentally worn due to rubbing friction from the ribbon reinforcement layer 13. The cushion layer 12 may be formed of, for example, a synthetic rubber and/or fabric. Cushion layer 12 may be omitted entirely in hose 1, or additional cushion layers 12 may be included in hose 1.

Cover 14 of hydraulic hose 1 may be a barrier between the external environment and the inner layers (i.e., ribbon reinforcement layer 13, cushion layer 12, and inner liner 11). Cover 14 may be formed of a material that is abrasion resistant and flexible across a wide range of temperatures. For example, cover 14 may be a synthetic rubber such as neoprene, or a plastic such as polyurethane.

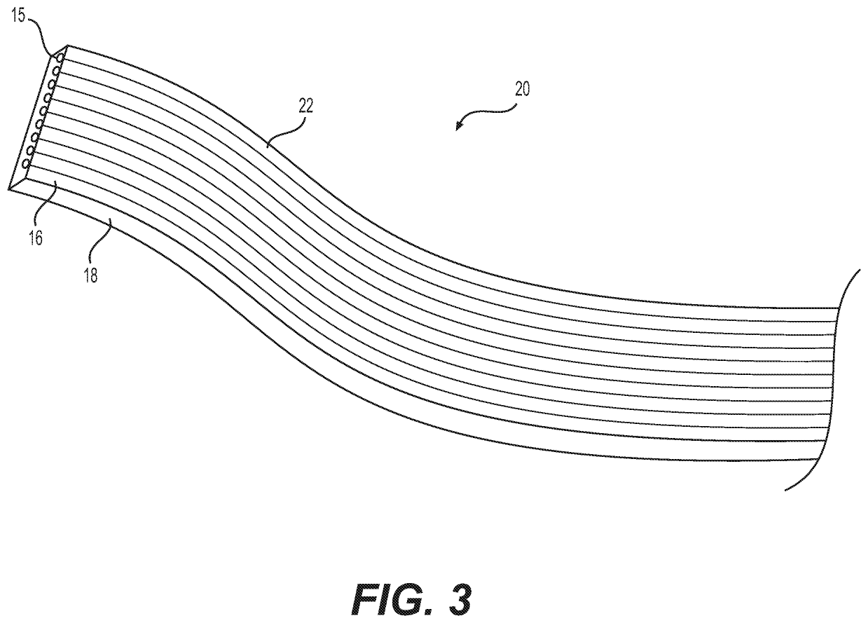

Ribbon reinforcement layer 13 may include one or more preformed ribbons 20. Referring to FIGS. 2 and 3, each ribbon 20 of reinforcement layer 13 may include a plurality of wires 15 formed in a strip of cushioning material 16. Wires 15 may be formed of a high tensile strength steel or other conventional wire material, and may have any appropriate gauge. Cushioning material 16 may be formed of, for example, a synthetic rubber. Wires 15 may be arranged along the ribbon 20 so as not to contact one another, so that cushioning material 16 separates the wires 15. For example, wires 15 may be arranged longitudinally along ribbon 20, generally evenly spaced, and parallel to one another, and parallel to a longitudinal side edge 18 of the ribbon 20. Wires 15 may extend to a surface of the ribbon 20, for example being flush or coplanar with a top surface 22 or a bottom surface of ribbon 20. Alternatively, wires 15 may be completely encased within the cushioning material 16 so that the wire does not form a portion of any surface of the ribbon 20. While only exemplary, ribbon 20 may be ⅝ inches wide, having 20 wires, and each wire 15 may have a gauge of 22.

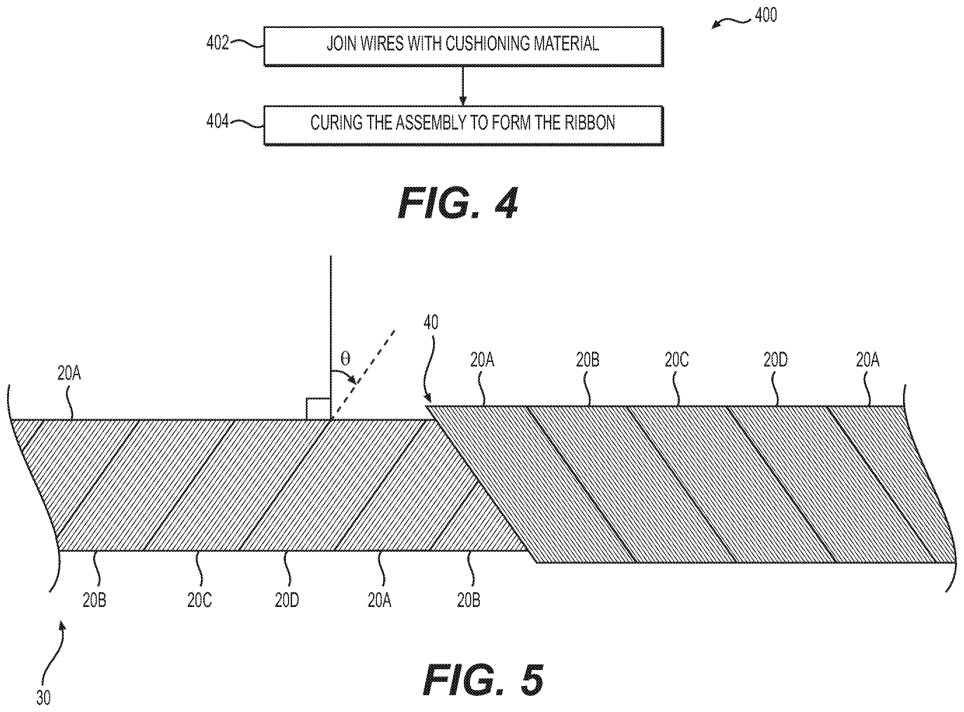

FIG. 4 is a flow chart for a process 400 of manufacturing ribbon 20 of the hydraulic hose 1 of FIG. 1. The ribbon 20 may be preformed—formed prior to assembly on hose 1. Process 400 may include a first step 402 of joining wires 15 with cushioning layer 16. The joining step 402 may be accomplished by using an alignment tool, such as a grooved rolling wheel (not shown), to arrange and urge the wires 15 into an uncured cushioning layer 16. The uncured nature of the cushioning layer allows the wires 15 to engage and be partially or fully encased by the cushioning layer 16. In step 404, the joined wires 15 and cushioning material are cured or vulcanized by any appropriate curing or vulcanization process to form the final ribbon 20. Alternatively, ribbon 20 could be formed by laying wires 15 between layers of cushioning material and curing or vulcanizing the cushioning layers together thereby securely encasing the wires 15 with cushioning material.

Referring back to FIG. 2, ribbon reinforcement layer 13 may include multiple layers of ribbon 20, such as ribbon layers 30, 40, 50, and 60. FIG. 2 illustrates four ribbon layers (30, 40, 50, 60), but it is understood that more or less layers could be used depending on the desired reinforcement (pressure rating) of hose 1. Further, while not shown, it is understood that each ribbon layer may be separated by a cushion layer, such as a cushion layer 12 as discussed above. For example, ribbon reinforcement layer 13 may include two layers, four layers, eight layers, etc. As shown in FIG. 5, ribbon layer 30 may be formed by a plurality of helically wound ribbons 20A-20D that are arranged edge-to-edge in a helical manner to form a uniform layer 30. While FIG. 5 shows ribbon layer 30 formed of four ribbons 20A-20D, more or less ribbons could be used, e.g., one, two, three, or more than four.

Also as shown in FIG. 5, ribbon layers 40, 50, and 60 may be formed on top of layer 30, with adjacent outer layers helically wound in opposite directions than the immediately adjacent inner layer. For example, layer 30 may be wound in a clockwise direction, and layer 40 (with ribbons 20A-20D) may be wound in a counterclockwise direction. Further, ribbon layer 50 may be formed in a clockwise direction, and ribbon layer 60 in a counterclockwise direction.

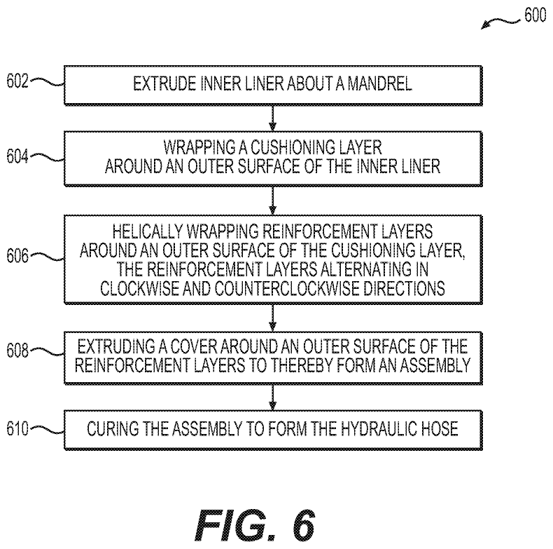

FIG. 6 is a flow chart for a process 600 of manufacturing the hydraulic hose 1 of FIG. 1. The process 600 may start by extruding the inner liner 11 about a mandrel (step 602). Next, a cushioning layer 12 may be wrapped around the inner liner 11 (step 604). The reinforcement layer 13 may then be formed by helically wrapping ribbons 20 into individual layers 30-60 in clockwise and counterclockwise directions (step 606) about the cushioning layer 12. As mentioned above, the first ribbon reinforcement layer 30 may have four ribbons 20A, 20B, 20C, and 20D that are helically wound in a clockwise direction, while the second ribbon reinforcement layer 40 may have four ribbons 20A-20C that are helically wound in a counterclockwise direction. Ribbons 20A-20D of layers 30-60 may be wound at any appropriate angle, for example, a winding angle θ of approximately 55° (FIG. 5). The cover 14 may then be extruded over the reinforcement layer 13 (step 608) to form a hose assembly. The hose assembly may then be labeled and cured (step 610). The wrapping of the inner liner 11 and the ribbons 20 about the hose 1 can be done in any conventional manner, such as with the use of a winding machine that feeds the mandrel through the winding machine as the layers are wound about hose 1.

### INDUSTRIAL APPLICABILITY

The present disclosure may find application in the production and use of hoses for fluid systems, such as hydraulic hoses for use in hydraulic systems.

The present disclosure may help to ensure that the wires 15 of the hose 1 are uniformly distributed about the hose 1, and of the appropriate tension on the hose 1. By combining the cushioning material 16 and the wires 15 to form a ribbon 20 prior to forming the hose, the wires 15 can be accurately positioned and set before they are applied to the hose 1. This can help avoid wire alignment problems (i.e., high wires, low wires, twisted wires, and gaps between wires). This may increase the life and safety of the hose 1, as the likelihood of failure of the hydraulic hose due to high wires, low wires, twisted wires, and gaps between wires, may be reduced. This may also reduce costs associated with hoses that fail prematurely (e.g., warranty costs, replacement costs, and down time of the machine/system using the hydraulic hose).

Another aspect of the above disclosure is that the hydraulic hose 1 may be more simple to manufacture by reducing the complexity of wrapping numerous wires about the hydraulic hose. For instance, by using ribbons 20 to create the ribbon reinforcement layer 13, instead of individually positioning hundreds of individual wires 15, manufacturing parts, set-ups, and system coordination may be reduced. This may reduce cost in maintenance and down time of the manufacturing facility.

It will be apparent to those skilled in the art that various modifications and variations can be made to the disclosed system without departing from the scope of the disclosure. Other embodiments of the system will be apparent to those skilled in the art from consideration of the specification and practice of the method disclosed herein. It is intended that the specification and examples be considered as exemplary only, with a true scope of the disclosure being indicated by the following claims and their equivalents.

What is claimed is:

1. A fluid hose, comprising:
an inner liner;
a reinforcement layer located radially outside of the inner liner; and
a cover;
the reinforcement layer including one or more preformed ribbons having a plurality of wires formed in a strip of cushioning material.

2. The fluid hose of claim 1, wherein the plurality of wires are generally evenly spaced apart from each other.

3. The fluid hose of claim 2, wherein the ribbon has a longitudinal edge, and the plurality of wires are generally parallel to each other and generally parallel to the longitudinal edge of the ribbon.

4. The fluid hose of claim 3, wherein the plurality of wires are completely encased within the strip of cushioning material.

5. The fluid hose of claim 3, wherein the plurality of wires are exposed at a surface of the strip of cushioning material.

6. The fluid hose of claim 3, wherein the wires are formed of steel, and the cushioning material is formed of a synthetic rubber.

7. The fluid hose of claim 6, wherein the wires and cushioning material are cured together prior to joining with the hose.

8. The fluid hose of claim 3, wherein the reinforcement layer includes a plurality of helically wound ribbons arranged side-to-side.

9. The fluid hose of claim 8, wherein the reinforcement layer includes multiple layers, each formed of a plurality of helically wound ribbons arranged side-to-side.

10. The fluid hose of claim 9, wherein the multiple layers includes one layer arranged in a clockwise direction, and another layer arranged in a counterclockwise direction.

11. A ribbon for use in forming a hydraulic hose, comprising:
a plurality of wires; and
a strip of cushioning material, the plurality of wires being formed in the strip of cushioning material.

12. The ribbon of claim 11, wherein the plurality of wires are generally evenly spaced apart from each other.

13. The ribbon of claim 12, wherein the ribbon has a longitudinal edge, and the plurality of wires are generally parallel to each other and generally parallel to the longitudinal edge of the ribbon.

14. The ribbon of claim 13, wherein the plurality of wires are completely encased within the strip of cushioning material.

15. The ribbon of claim 13, wherein the plurality of wires are exposed at a surface of the strip of cushioning material.

16. The ribbon of claim 13, wherein the wires are formed of steel, and the cushioning material is formed of a synthetic rubber.

17. The ribbon of claim 16, wherein the wires and cushioning material are cured together prior to joining with the hose.

18. A method of making a fluid hose, comprising:
forming an inner liner;
forming a reinforcement layer radially outside the inner liner; and
forming a cover radially outside the reinforcement layer;
the forming of the reinforcement layer includes helically winding one or more ribbons radially outside the inner liner, the ribbons including a plurality of wires arranged in a strip of cushioning material.

19. The method of making a fluid hose of claim 18, wherein helically winding one or more ribbons includes helically winding a plurality of ribbons side-to-side.

20. The method of making a fluid hose of claim 18, wherein the forming of the reinforcement layer further includes forming multiple radially adjacent layers of helically wound ribbons arranged side-to-side, the radially adjacent layers arranged in alternating clockwise and counterclockwise directions.
